(19) United States
(12) Patent Application Publication
(10) Pub. No.: US 2016/0343099 A1
(43) Pub. Date: Nov. 24, 2016

(54) AUTOMATED TRAFFIC SENSOR PLACEMENT PLANNING

(71) Applicant: INTERNATIONAL BUSINESS MACHINES CORPORATION, Armonk, NY (US)

(72) Inventors: MEINOLF SELLMANN, Yorktown Heights, NY (US); Zhili Zhou, Singapore (SG)

(21) Appl. No.: 14/719,526

(22) Filed: May 22, 2015

(51) Int. Cl. G06Q 50/26; G06Q 10/06; G08G 1/01; E01C 1/00; E01F 11/00

(52) U.S. Cl. CPC G06Q 50/26; E01C 1/002; E01F 11/00; G08G 1/01; G06Q 10/06313

(57) ABSTRACT

A system for automated traffic sensor placement includes a sensor placement module configured to determine where a plurality of traffic flow monitoring sensors are to be placed within a network of roadways to observe or infer traffic flow volume through each of a plurality of roadway arcs of interest. An arc prioritization module is configured to determine a relative priority of each of the arcs of interest. A sensor selection module is configured to receive an indication of how many sensors are available to deploy and select a corresponding number of sensors for deployment from among the traffic flow monitoring sensors to be placed based on the relative arc priorities determined by the arc prioritization module.

### TECHNICAL FIELD

The present disclosure relates to sensor placement and, more specifically, to automated approaches for the planning of traffic sensor placement.

### DISCUSSION OF THE RELATED ART

Traffic sensors are devices that are able to observe a state of traffic flow within a particular area of operation. One common example of a traffic sensor is the inductive loop detector. Such a device may be embedded within road pavement and may be able to detect a level of traffic passing thereabove with the knowledge that a metallic vehicle passing over the sensor will create a change in the magnetic field in the vicinity of the sensor, thereby inducing an electrical current that may be measured. Another common example of a traffic sensor may be a video camera whose output is analyzed using computer vision techniques to ascertain information as to how traffic is moving through the area under surveillance. Radar may also be used to track the presence and speed of traffic moving through a particular location.

Traffic sensors may be particularly useful for municipalities and other entities engaged in supporting traffic operations and planning traffic-related infrastructure. However, traffic sensors may be expensive to install and maintain. Accordingly, limitations on available resources may prevent traffic sensors from being installed at every area of interest.

Existing approaches for the installation of traffic sensors may utilize an expert planner whose job it is to determine a roadway or intersection that traffic flow information is most needed for and to install one or more traffic sensors at the determined roadway or intersection.

### SUMMARY

A system for automated traffic sensor placement includes a sensor placement module configured to determine where a plurality of traffic flow monitoring sensors are to be placed within a network of roadways to observe or infer traffic flow volume through each of a plurality of roadway arcs of interest. An arc prioritization module is configured to determine a relative priority of each of the plurality of arcs of interest. A sensor selection module is configured to receive an indication of how many sensors are available to deploy and select a corresponding number of sensors for deployment from among the traffic flow monitoring sensors to be placed based on the relative priorities determined by the arc prioritization module.

The sensor placement module may receive a description of the characteristics of the network of roadways, may receive an indication of locations of preexisting sensors placed within the network of roadways, and may use this information to determine where the plurality of traffic flow monitoring sensors are to be placed.

The network of roadways may include preexisting traffic flow monitoring sensors and the plurality of traffic flow monitoring sensors to be placed are additional traffic flow monitoring sensors.

The sensor placement module may determine where the plurality of traffic flow monitoring sensors are to be placed by minimizing a total number of sensors needed to be deployed within the network of roadways to observe or infer traffic flow volume through each of a plurality of roadway arcs of interest.

The sensor placement module may determine that at least one of the plurality of traffic flow monitoring sensors are to be placed such that traffic flow volume through at least one of the plurality of roadway arcs of interest is inferred but not directly observed.

The arc prioritization module may utilize an approach for prioritization by static network analysis for determining the relative priority of each arc of interest.

The arc prioritization module may utilizes an approach for prioritization based on up-stream proximity to historically congested roadways for determining the relative priority of each of the arcs of interest.

The plurality of traffic flow monitoring sensors may include at least one inductive loop detector.

The plurality of traffic flow monitoring sensors may include at least one radar device.

The plurality of traffic flow monitoring sensors may include at least one video surveillance device.

The arc prioritization module may determine the relative priority of each of the plurality of arcs of interest using user input.

The arc prioritization module may automatically determine the relative priority of each of the plurality of arcs of interest based on one or more characteristics of the network of roadways.

A method for automated traffic sensor placement includes receiving a description of a network of roadways from a user, the network of roadways including a plurality of arcs. A list of arcs of interest is received from the user. A minimum number of sensors that is sufficient to observe or infer traffic flow characteristics at each of the arcs of interest is determined and an installation location within the network of roadways is determined for each of the minimum number of sensors. The arcs of interest are prioritized. A maximum number of sensors that can be installed is received from a user. Up to a maximum number of sensors are selected from the determined installation locations based on the prioritization thereof.

Prioritizing the arcs of interest may be performed based on user input.

Prioritizing the arcs of interest may be automatically performed based on one or more characteristics of the network of roadways.

A sensor disposed at one of the determined installation locations within the network of roadways may be used to infer, but not directly observe, traffic flow volume through at least one of the plurality of roadway arcs of interest.

Prioritizing each of the installation locations may include static network analysis for determining a relative priority of each of the arcs of interest.

Prioritizing each of the installation locations may include prioritization based on up-stream proximity to historically disrupted roadways for determining a relative priority of each of the arcs of interest.

A method for automated traffic sensor placement includes receiving a description of a network of roadways. The network of roadways includes a plurality of arcs. The description includes an indication of legal and physical constraints on traffic patterns through the network of roadways. An indication as to which of the plurality of arcs are arcs of particular interest is received. A minimum number of traffic flow sensors required to observe or infer traffic flow characteristics at each of the arcs of interest is inferred. A location of installation for each of the minimum number of traffic flow sensors is determined using the indication of legal and physical constraints on traffic patterns through the network of roadways as well as a priori knowledge of likely driver navigation patterns. Each of the arcs of particular interest are prioritized. Up to a maximum number of sensors are selected from the determined location of installations based on the prioritization thereof.

The traffic flow characteristics of at least one of the arcs of particular interest may be inferred, but not directly observed, by the minimum number of traffic flow sensors and their locations of installation.

The prioritizing may include static network analysis for determining a relative priority of each of the arcs of particular interest.

The prioritizing may be based on up-stream proximity to historically congested roadways for determining a relative priority of each of the arcs of particular interest.

The a priori knowledge of likely driver navigation patterns may include an understanding that drivers tend to avoid making u-turns.

The determining of the minimum number of traffic flow sensors required to observe or infer traffic flow characteristics at each of the arcs of interest may include taking into account the location of all pre-existing sensors within the network of roadways.

The traffic flow sensors may include an inductive loop sensor, a radar or a computer vision apparatus.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a map diagram illustrating an exemplary roadway for receiving automatic sensor selection in accordance with exemplary embodiments of the present invention;

FIG. 2 is a schematic diagram illustrating analytical modules for performing automated sensor planning in accordance with exemplary embodiments of the present invention;

FIG. 3 is a schematic diagram illustrating relationships between various components of a system for automated sensor placement in accordance with exemplary embodiments of the present invention;

FIG. 4 is a diagram illustrating static network analysis considerations, such as number of arcs leaving a node (“out-degree”), which may be used for arc prioritization;

FIG. 5 is a diagram illustrating an approach for automatically prioritizing sensor placement based on proximity and being upstream of historically congested or accident-prone traffic arcs in accordance with exemplary embodiments of the present invention; and

FIG. 6 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide systems and methods for automatically determining where traffic sensors are to be installed. However, rather than simply identifying locations from where traffic data is most desirable and installing traffic sensors at those locations, exemplary embodiments of the present invention make one or more key inferences about how sensed traffic volume at one location is likely to affect traffic volumes at other locations so that a minimum number of traffic sensor may be deployed while still providing an indication of traffic flow through all areas identified as critical, by using a combination of directly sensed traffic flow as well as traffic flow inferred from sensors at other locations, in combination with prior knowledge about traffic flow regulations, likely driver behavior and the understanding that, in certain cases, a rate of traffic flowing into a particular area along all possible avenues is likely to match a rate of traffic flowing out of a particular area along all possible avenues.

An example of this approach for this inferential traffic analysis will now be described with reference to FIG. 1. FIG. 1 is a map diagram illustrating an exemplary network of roadways. The network 10 includes two lanes of south-eastbound traffic converging with one lane of eastbound traffic and then opening into a traffic circle that has exits for northbound traffic, eastbound traffic, and southbound traffic. Assuming that knowledge about traffic flow is desired at locations 11, 12, 13, 14, 15, 16, and 17, prior art approaches for traffic analysis may position traffic sensors at all locations. However, exemplary embodiments of the present invention, operating on knowledge of traffic rules through the area in question, including directions of traffic, legal turns, etc., and operating on the assumption that drivers tend to obey the traffic laws, avoid u-turns, etc., may be able to infer traffic patterns though one or more of the desired locations by directly monitoring the traffic flow though other locations, which may be, but need not be, desired locations. For example, taking into account that traffic rules mandate a particular direction to traffic in each lane, as illustrate by the block arrows, and taking into account the fact that u-turns are not permitted, or are otherwise not commonly performed, it can be assumed that the volume of traffic through location 13 is equal to the flow of traffic through locations 11 and 12 combined. Total flow may then be calculated based on the flow of traffic and the number of open and available lanes of traffic. Moreover, the flow though location 15 may be calculated as the flow through location 13 reduced by the flow through location 14 while the flow though location 16 may be calculated as the flow though location 15 minus the flow through location 17. It may be assumed that traffic will not remain in the traffic circle indefinitely and that drivers, for the most part, will not loop around the traffic circle more than once. While it is understood that there may be exceptions, exemplary embodiments of the present invention may make these assumptions for the purposes of arriving at a good approximation of traffic conditions at unmonitored locations.

Accordingly, in planning sensor placement, exemplary embodiments of the present invention may be able to determine a minimum number of sensors and their desired locations so as to provide traffic flow information through all locations identified as desired, either by direct observation or by inference, as described by example above. Indeed, exemplary embodiments of the present invention may be used to automatically identify a plurality of desired locations and determine a minimum number of sensors required to determine traffic flow conditions at each of the plurality of desired locations, by directly observing a plurality of observational locations and inferring, from the directly observed plurality of observational locations in combination with known traffic rules and likely driver behavior, traffic flow conditions through at least one of the desired locations. Flow conditions through the remainder of the desired locations may be directly observed as some locations may be both part of the plurality of desired locations and the plurality of observational locations. In some circumstances, it may be possible that traffic conditions through all desired locations are inferred and that none of the observational locations are also desired locations. In other circumstances, it may be possible that all of the observational locations are also desired locations, but in this case, the set of desired locations may include locations that are not observational locations as exemplary embodiments of the present invention may include at least one desired location, the traffic flow through which is inferred from one or more observational locations that may be, but need not be, desired locations.

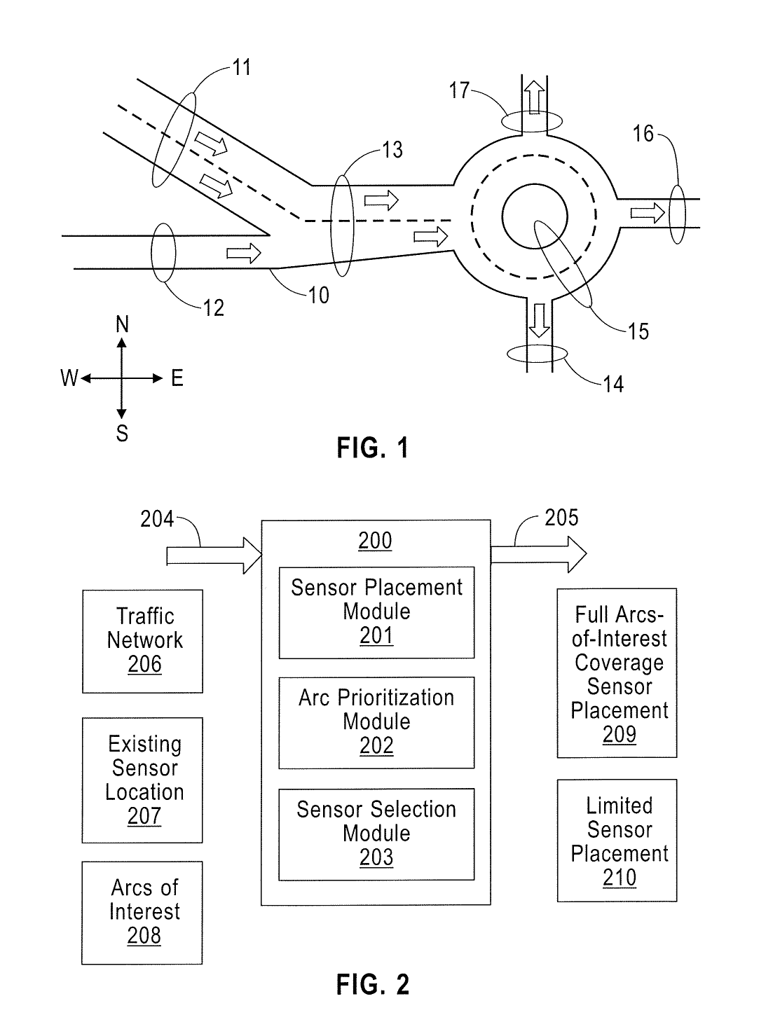

In performing automated sensor planning, exemplary embodiments of the present invention may utilize three analytical modules. Each analytical module may be embodied using one or more computer systems or logic device and multiple analytical modules may be embodied within a single computer system or logic device. FIG. 2 is a schematic diagram illustrating analytical modules for performing automated sensor planning in accordance with exemplary embodiments of the present invention.

Automated sensor planning may be performed using a sensor-planning device 200, which may be embodied as one or more computer systems or other logic processing devices. The sensor-planning device 200 may receive, as input 204, an understanding of traffic flow rules and constraints as well as an indication of likely traffic patterns followed by drivers, which may include traffic network characteristics 206. A user may also provide, as input 204, various preferences and data, which may include a list of traffic locations, referred to herein as arcs, as well as a prioritization of the arcs of interest 208, which may represent an indication of the relative value of knowing traffic flow conditions through each of the various roadway segments. The user need not provide the prioritization of the arcs of interest 208, as this may be determined by the arc prioritization module 202, for example, as described below. The sensor-planning device 200 may also take as input 204, the locations of existing sensor locations 207 as most often sensor placement will not be performed from scratch, but rather, a set of sensors may already be in place at the time of the execution of exemplary embodiments of the present invention. It is to be understood, however, that exemplary embodiments of the present invention may be used to design a sensor network from scratch, in which case, the existing sensor locations 207 may be a null set.

The sensor-planning device 200 may include a sensor placement module 201. The sensor placement module 201 may use the input information pertaining to the traffic flow rules and constraints (traffic network 206) and may determine a minimum number of sensors needed, and their respective placement locations, in order to either observe or infer traffic flow information though all provided desired locations according to the list of arcs that are of interest 208. Where some number of sensors have already been installed within the traffic network, as specified by the existing sensor location information 207, the sensor placement module 201 may determine a minimum number of additional sensors, and corresponding placement locations, needed to achieve the goal of observed or inferred traffic flow though all desired locations. The operation of the sensor placement module 201 will be described in greater detail below.

The sensor-planning device 200 may also include an arc prioritization module 202. Each section of the traffic network that extends between intersections, merges, exists, and other traffic elements that can change traffic flow, may be referred to herein as an arc. The arc prioritization module 202 may determine a relative value of knowing traffic flow patterns thorough each of the arcs of interest 208, for example, the arc prioritization module 202 may determine which of the arcs of interest 208 are more important than others. The operation of the arc prioritization module 202 will be described in greater detail below.

The sensor-planning device 200 may provide as output 205 a set of locations where sensors should be placed to determine traffic conditions at all desired locations with minimal sensor placement. This output may be referred to as the full arc sensor placement plan 209.

The sensor-planning device 200 may also include a sensor selection module 203. Assuming that insufficient resources are available to install all required sensors, the sensor selection module 203 may utilize the order of priority for the arcs of interest, as determined by the arc prioritization module 202 and/or provided or changed by the operator, and the listing of needed sensors provided by the sensor placement module 201 to determine, for a limited amount of resources, which sensors are to be installed first. This output may be referred to as the limited sensor placement plan 210. The operation of the sensor selection module 203 will be described in greater detail below.

Maintaining a high quality sensor network may facilitate the efficient operation of traffic networks, however, installing and maintaining traffic sensors may be quite expensive and accordingly, it may not be practical to install traffic sensors at every arc of interest. Accordingly, exemplary embodiments of the present invention may automatically determine strategic locations for traffic sensors that allow users to observe the links that are most important both from a planning and an operations perspective. □ By optimizing sensor placement, exemplary embodiments of the present invention may be able to minimize costs by inferring traffic patterns at unobserved arcs using such a priori knowledge as flow conservation constraints. Based on this knowledge the system infers flow on links not directly observed by sensors, whereby the latter are placed strategically within the given network.

This inferential knowledge may additionally include knowledge of natural traffic patterns, e.g. the fact that, if any, few vehicles are likely to U-turn at most intersections (exceptions are possible). User may accordingly balance the trade-off between inference accuracy and cost which is of strategic importance. Exemplary embodiments of the present invention may allow both, to require maximal visibility while minimizing costs, or to limit the costs and optimize long-term network visibility. As discussed above, exemplary embodiments of the present invention may take into account the locations of sensors that are already installed. Additionally, users may specify the links in the network that are of particular importance to them, for example, by changing the arc priority list as computed by the arc prioritization module 202.

The sensors installed may be passive sensors, which measure macro-characteristics of traffic flow in general such as traffic volume and occupancy, or active sensors, which measure micro-characteristics from individual vehicles, for instance vehicle type. Accordingly, passive sensors may provide information about the whole traffic flow at specific locations. Specifically, when any metallic vehicle passes over an inductive loop detector (passive sensor), which is embedded in□the road pavement, the change in the magnetic field induces an electrical current that indicates the vehicle passage, and allows the computation of vehicle occupancy at this location for a certain time period, based on the shape of the electrical signal. Active sensors target a specific category of traffic equipped with a short-range communication device, and provide a more refined information, such as speed and for instance limited information on the vehicles origin and destination (in the case automated payment systems on toll roads). Sensors thereby provide local information about the traffic state. For planning and operational perspectives, exemplary embodiments of the present invention provide procedures for maximizing the collection of local information about the whole traffic flow, given certain budget constraints and without prior knowledge on onboard technology. By design, passive sensors may provide information on the whole traffic flow on road segments, without assumption on the instrumentation available in vehicles.

Exemplary embodiments of the present invention may thereby be described herein as planning for the placement of passive sensors, however, it is to be understood that the invention is no so limited, and exemplary embodiments of the present invention may be used to place active sensors in addition to or instead of passive sensors.

The sections of roadway being monitored may be referred to herein as arcs. Additionally, the roadway arcs may be contemplated in terms of a series of nodes and links that connect these nodes. Those links that have sensor placement therein may be referred to as observed links while those links that do not have sensor placement therein may be referred to as non-observed links. While it is understood that complete information about traffic conditions may be obtained by placing sensors on every arc in the traffic network, since passive traffic sensors are costly and require maintenance, this solution quickly becomes prohibitively expensive. Traditionally, practitioners deployed a large amount of traffic sensors on a case-by-case basis, without a systematic study of the quantity and locations of sensors. Exemplary embodiments of the present invention take a holistic approach to the selection of new locations for traffic sensors by minimizing the number of placed sensors and maximizing traffic network coverage for existing traffic networks with pre-placed sensors. The system may determine an optimal sensor placement with minimal sensor number to achieve full traffic network coverage, whereby flow volumes on links are observed directly or inferred by the properties of undisturbed flowing traffic, in particular, but not limited to, flow conservation and natural legal traffic patterns such as driver aversion to U-turns. This natural legal traffic pattern information does not depend on historical data and can be updated directly, for example when new turning restrictions are imposed. This is in contrast to using historical data on turning fractions in which changes to roadways may render historical data non-applicable.

As discussed above, systems for the automatic placement of roadway sensors may include a sensor placement module 201, an arc prioritization module 202, and a sensor selection module 203. The sensor placement module may be tasked with determining a minimal number of (additional) sensor locations so that any legal and likely traffic flow is uniquely determined on all arcs of interest when the flow volumes at the sensor locations are known. Formally, this may be represented as G=(N, A), where G denotes a directed network, which represents the traffic network with node□set N and directed arc set A. The set of arcs on which sensors have already been placed may be denoted with P⊂A. The set of arcs on which it is desired that flow volumes be monitored (either directly or by□means of inference) may be denoted as Q⊂A. A node cεN may be referred to as a centroid when flow may be originating or ending at c. For all centroid nodes c it may be assumed that the total flow out of c (Sc) and the total flow into c (Dc) is known. Here□C may represent the subset of N that consists of all centroid nodes. All nodes in N that are not centroids may be called transit nodes. For these nodes it must hold that the total flow into the node equals the total flow out of the node. Here T may represent the subset of N that consists of all transit nodes.

The legal flow in G may be represented as the function F: R such that:

Σ_{(i,c)εA}F(a)=S_{c} for all cεC (1)

Σ_{(c,f)εA}F(a)=D_{c} for all cεC (2)

Σ_{(i,a)εA}F(a)=Σ_{(a,f)εA}F(a) for all aεT (3)

The sensor placement problem may then include finding a set, Z with P⊂Z⊂A such that for any two legal flows X, Y: A→R with X(a)=Y(a) for all aεZ, it holds that X(a)=Y(a) for all aεA and such that |Z| is minimal. The task of the sensor placement module is to solve this sensor placement problem.

Solving the sensor placement problem may be computationally expensive, especially in an urban traffic network with perhaps more than 9,000 nodes. Exemplary embodiments of the present invention may accordingly implement a Bender's decomposition approach. The control problem proposes a minimal assignment of sensors to arcs in the network. The adversary problem then is to find two flows that are equal on all arcs where a sensor was placed by the controller, but which differ in volume on at least one arc that needs to be observed. If the adversary cannot find such flows, then the proposed assignment guarantees that the flow may be uniquely inferred on all important arcs.

On the other hand, if the adversary finds two such flows, then these same flows can be used to prove that any other sensor placement is not satisfactory which does not place a sensor on at least one arc where the flows differ. Consequently, we can infer that at least one sensor must be placed on an arc where the two flows were found to differ. This so-called Bender's cut is then returned to the controller and added as a mandatory constraint that must be satisfied in future proposals where sensors should be placed.

To make the Bender's cuts stronger, an objective may be added to the adversary to try and find two flows that differ on some, but preferably few, arcs. Also, redundant constraints may be added to the initial controller problem to speed up the search for satisfying sensor placements. Using this approach, exemplary embodiments of the present invention may be able to efficiently find a provably minimal sensor placement for a traffic network with over 9,000 nodes and more than 20,000 arcs.

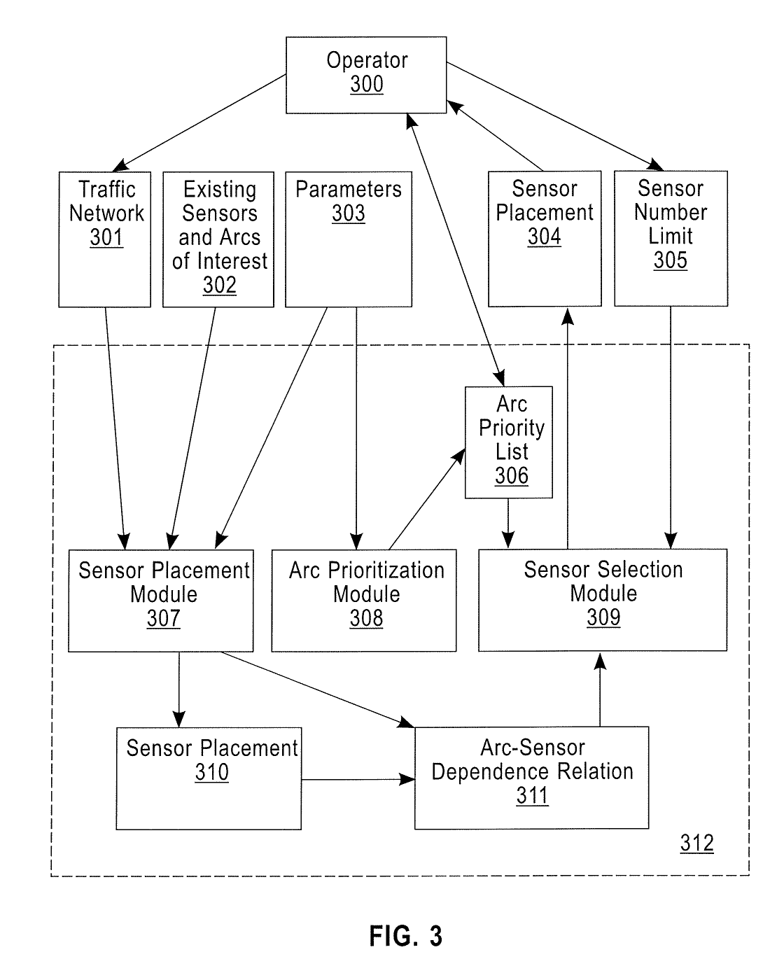

FIG. 3 is a schematic diagram illustrating relationships between various components of a system for automated sensor placement in accordance with exemplary embodiments of the present invention. Here, a human operator 300 may observe existing sensor placement 305 and set budgetary constraints as to how many additional sensors may be added 306. The human operator 300 may also provide detailed information concerning the features of the traffic network 301. These features may include the nodes and arcs of the roadways, the physical and legal restrictions on movement, and traffic capacity. The system for automated sensor placement 313 may include a sensor placement module 308, an arc prioritization module 309 and a sensor selection module 310, as described above. The sensor placement module 308 may receive the traffic network information 301 provided by the operator 300, information about exiting sensor placement 302 and a list of arcs of interest 303 and various parameters 304 that influence where sensors may be placed and what arcs should be monitored. The sensor placement module 308 may then determine sensor placement 311 and relationship dependencies between arcs of interest and new sensors 312, whereby the latter determines, for each arc of interest, which new sensors must be placed to gain visibility, either directly or by inference, on the respective arc. The arc prioritization module 309 may contribute to the arc priority list 307 based on the supplied parameters 304. The operator 300 may also manually contribute to, change, override, and/or constrain the arc priority list 307. The sensor selection module 310 may ultimately determine, given the budgetary constraints 306 set by the operator 300, where additional sensors are to be placed. In this way, the sensor selection module 310 contributes to the sensor placement 305. The sensor selection module 310 may utilize the arc priority list 307 in making this determination.

An objective of the arc prioritization module 309 is to order the arcs of interest (the arcs in set Q) according to the priority to achieve the ability to monitor flow volumes on that arc.

The prioritization module may take, as input, the traffic network structure and the sensor placement evaluation rules and may provide, as output, a priority list for all arcs of interest. In so doing, the prioritization module 309 may prioritize arcs according to static or historic network data. The arc prioritization module 309 may support various different evaluation rules for sensor placement. These various rules may provide for different perspectives. Examples of these rules may include: (1) prioritization by static network analysis (for example, adjacent arc degrees), and (2) prioritization based on historical traffic data (for example, focus on arcs upstream of arcs known to be disrupted often). In terms of computational effort needed, arc prioritization need not be critical.

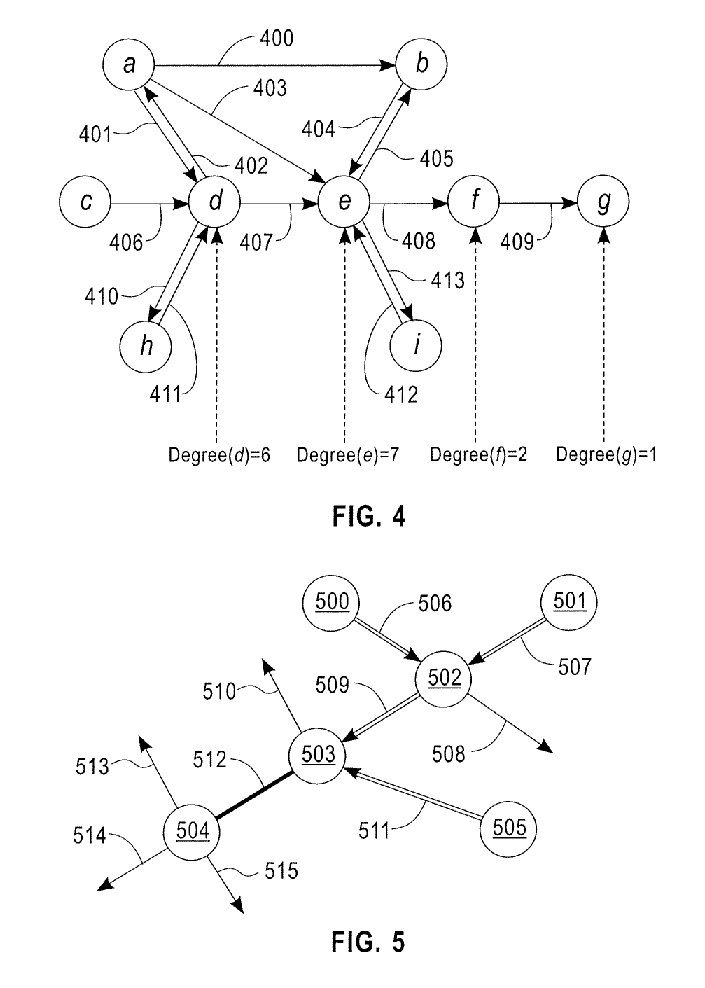

In using static network structure for arc prioritization, traffic arcs may be ranked by considering the number of traffic arc sources and sinks related to each node that connect to the arcs being ranked. The count of these sources and sinks may be referred to herein as the degree. For example, if a node has one arc that feeds it and one arc from which traffic leaves, that node has a degree of two. If there are two arcs in and two arcs out, the degree may be four, etc. The higher the degree of sinks and sources at a node, the higher the connectivity of the traffic arc. The ranking of the arcs may thus be determined based on the nodes that connect to it by rules like “the higher the connectivity, the higher the rank.” FIG. 4 is a diagram illustrating various node/arcs and the sources and sinks that correspond thereto. Nodes a through i are illustrated. Arcs that connect these nodes are shown as arrowed lines 400-413. The arcs may be ranked according to the degree of their nodes. For example, node d is shown to have a degree of 6 (401, 402, 406, 407, 410, and 411). Similarly, node e is shown to have a degree of 7 (403, 404, 405, 407, 408, 412, and 413), node f is shown to have a degree of 2 (408 and 409), and node g 406 is shown to have a degree of 1 (409). Thus, a static node structure for arc prioritization may rank arc 407 ahead of arc 409, as arc 407 connects to node d of degree 6 and node e of degree 7 (thereby having a connectivity of 13) while arc 409 connects to node f of degree 2 and node g of degree 1 (thereby having a connectivity of 3).

As described above, another technique that may be used to automatically prioritize sensor placement is based on historical traffic data. From the perspective of traffic operation, traffic flows close to traffic congestions and/or accident-prone locations may be of primary interest. Hence, high priority may be attributed to arcs that are upstream of and/or adjacent to historically frequently disrupted arcs.

FIG. 5 is a diagram illustrating an approach for automatically prioritizing sensor placement based on proximity and being upstream of historically congested traffic arcs in accordance with exemplary embodiments of the present invention. The diagram includes a set of nodes 500-505. The arcs connected to the nodes are illustrated as the arrows 506-515. Downstream arcs which exclusively take traffic away from nodes are depicted with a single-lined arrow. Downstream arcs include arcs 508, 510, 513, 514, and 515. According to this prioritization approach, arcs that are exclusively downstream are not given high priority. Highest priority may be attributed to those arcs that deliver traffic to a node. These arcs may be referred to herein as upstream arcs as they occur upstream of nodes. Upstream arcs are shown with double-lined arrows and include arcs 506, 507, 509, and 511. Arc 512 is a historically congested arc, and although it is also an upstream arc, highest priority may be attributed to those upstream arcs that are upstream to and closest to the arc of historical congestion. Accordingly, by this approach, arcs 509 and 511 may be assigned highest priority while arcs 506 and 507 may be assigned next-highest priority. The downstream arcs that affect upstream traffic flows such as arcs 508 and 510 may be assigned a lesser degree of priority and finally, those downstream arcs that are down stream of the area of historic congestion, such as arcs 513, 514, and 515, may be assigned least priority.

Given a hard limit on the number of sensors that may be added at a given time, exemplary embodiments of the present invention may utilize a sensor selection module to select sensors that have been proposed by the sensor placement module so that flow volumes on arcs in Q may be monitored in the order provided by the arc prioritization module. For example, the sensor selection module may analyze the solution provided by the sensor placement module and identify, for all arcs of interest, which sensors are needed to uniquely infer the flow on the arc. Then, the module may consider each arc in the order of decreasing rank as provided by the arc prioritization module, and the sensors needed to obtain visibility of the current arc may be added to the current set of selected arcs. This procedure may stop when the number of selected sensors would exceed the given limit on the total number of sensors.

The modules discussed above, such as the sensor placement module, the arc prioritization module, and the sensor selection module may be embodied as programs of instruction executed on one or more computer systems. For example, each module may be embodied as a computer system running computer code written to allow the computer system to perform the specified function.

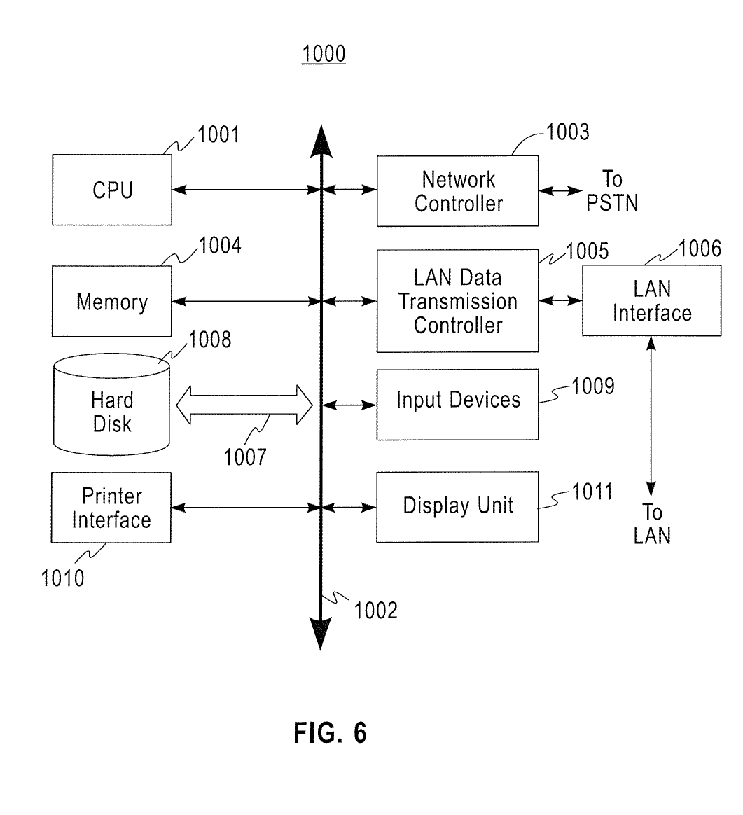

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for automated traffic sensor placement, comprising:
a sensor placement module configured to determine where a plurality of traffic flow monitoring sensors are to be placed within a network of roadways to observe or infer traffic flow volume through each of a plurality of roadway arcs of interest;
an arc prioritization module configured to determine a relative priority of each of the plurality of arcs of interest; and
a sensor selection module configured to receive an indication of how many sensors are available to deploy and select a corresponding number of sensors for deployment from among the traffic flow monitoring sensors to be placed based on the relative priorities determined by the arc prioritization module.

2. The system of claim 1, wherein the sensor placement module receives a description of the characteristics of the network of roadways, receives an indication of locations of preexisting sensors placed within the network of roadways, and uses this information to determine where the plurality of traffic flow monitoring sensors are to be placed.

3. The system of claim 1, wherein the network of roadways includes preexisting traffic flow monitoring sensors and the plurality of traffic flow monitoring sensors to be placed are additional traffic flow monitoring sensors.

4. The system of claim 1, wherein the sensor placement module determined where the plurality of traffic flow monitoring sensors are to be placed by minimizing a total number of sensors needed to be deployed within the network of roadways to observe or infer traffic flow volume through each of a plurality of roadway arcs of interest.

5. The system of claim 1, wherein the sensor placement module determines that at least one of the plurality of traffic flow monitoring sensors are to be placed such that traffic flow volume through at least one of the plurality of roadway arcs of interest is inferred but not directly observed.

6. The system of claim 1, wherein the arc prioritization module utilizes an approach for prioritization by static network analysis for determining the relative priority of each arc of interest.

7. The system of claim 1, wherein the arc prioritization module utilizes an approach for prioritization based on up-stream proximity to historically congested roadways for determining the relative priority of each of the arcs of interest.

8. The system of claim 1, wherein the plurality of traffic flow monitoring sensors includes at least one inductive loop detector.

9. The system of claim 1, wherein the plurality of traffic flow monitoring sensors includes at least one radar device.

10. The system of claim 1, wherein the plurality of traffic flow monitoring sensors includes at least one video surveillance device.

11. The system of claim 1, wherein the arc prioritization module determines the relative priority of each of the plurality of arcs of interest using user input.

12. The system of claim 1, wherein the arc prioritization module automatically determines the relative priority of each of the plurality of arcs of interest based on one or more characteristics of the network of roadways.

13. A method for automated traffic sensor placement, comprising:
receiving a description of a network of roadways from a user, the network of roadways including a plurality of arcs;
receiving a list of arcs of interest from the user;
determining a minimum number of sensors that is sufficient to observe or infer traffic flow characteristics at each of the arcs of interest and determining an installation location within the network of roadways for each of the minimum number of sensors;
prioritizing the arcs of interest;
receiving, from the user, a maximum number of sensors that can be installed; and
selecting up to the maximum number of sensors from the determined installation locations based on the prioritization thereof.

14. The method of claim 13, wherein prioritizing the arcs of interest is performed based on user input.

15. The method of claim 13, wherein prioritizing the arcs of interest is automatically performed based on one or more characteristics of the network of roadways.

16. The method of claim 13, wherein a sensor disposed at one of the determined installation locations within the network of roadways is used to infer, but not directly observe, traffic flow volume through at least one of the plurality of roadway arcs of interest.

17. The method of claim 1, wherein prioritizing each of the installation locations includes static network analysis for determining a relative priority of each of the arcs of interest.

18. The method of claim 1, wherein prioritizing each of the installation locations includes prioritization based on up-stream proximity to historically disrupted roadways for determining a relative priority of each of the arcs of interest.

19. A method for automated traffic sensor placement, comprising:
receiving a description of a network of roadways, the network of roadways including a plurality of arcs, the description including an indication of legal and physical constraints on traffic patterns through the network of roadways;
receiving an indication as to which of the plurality of arcs are arcs of particular interest;
determining a minimum number of traffic flow sensors required to observe or infer traffic flow characteristics at each of the arcs of interest, and determining a location of installation for each of the minimum number of traffic flow sensors, using the indication of legal and physical constraints on traffic patterns through the network of roadways as well as a priori knowledge of likely driver navigation patterns;
prioritizing each of the arcs of particular interest; and
selecting up to a maximum number of sensors from the determined location of installations based on the prioritization thereof.

20. The method of claim 19, wherein the traffic flow characteristics of at least one of the arcs of particular interest is inferred, but not directly observed, by the minimum number of traffic flow sensors and their locations of installation.

21. The method of claim 19, wherein the prioritizing includes static network analysis for determining a relative priority of each of the arcs of particular interest.

22. The method of claim 19, wherein the prioritizing is based on up-stream proximity to historically congested roadways for determining a relative priority of each of the arcs of particular interest.

23. The method of claim 19, wherein the a priori knowledge of likely driver navigation patterns includes an understanding that drivers tend to avoid making u-turns.

24. The method of claim 19, wherein the determining of the minimum number of traffic flow sensors required to observe or infer traffic flow characteristics at each of the arcs of interest includes taking into account the location of all pre-existing sensors within the network of roadways.

25. The method of claim 19, wherein the traffic flow sensors include an inductive loop sensor, a radar or a computer vision apparatus.
